(19) United States
(12) Patent Application Publication
(10) Pub. No.: US 2006/0046769 A1
(43) Pub. Date: Mar. 2, 2006

(54) Radio preset system for phone numbers

(75) Inventor: Uma Arun, Novi, MI (US)

Correspondence Address: General Motors Corporation;Legal Staff, Mail Code 482-C23-B21, 300 Renaissance Center, P.O. Box 300, Detroit, MI, 48265-3000, US

(73) Assignee: General Motors Corporation

(21) Appl. No.: 10/933,163

(22) Filed: Sep. 2, 2004

(51) Int. Cl. H04M 1/00

(52) U.S. Cl. 455/550.1; 455/563

(57) ABSTRACT

A method of initiating a wireless phone call from a mobile vehicle. The method includes storing at least one phone number in a vehicle communication system. The vehicle communication system includes a radio in communication with a telematics unit. The method further includes linking the stored phone number to a radio button, receiving a radio button input, while in a communication mode and placing the call from the telematics unit to the phone number linked to the radio button associated with the radio button input.

### FIELD OF THE INVENTION

This invention relates generally to a telematics system radio presets system. In particular, the invention relates to a method, system and computer usable medium for establishing radio presets in a mobile vehicle.

### BACKGROUND OF THE INVENTION

Speech recognition systems are used within vehicles with telematics units to initiate phone calls from the in-vehicle mobile phone. The user states one of the nametags associated with a phone number and the telematics unit initiates the phone call. The user is sometimes confused about the nametags. For example, a user may ask to call “Mother” when the nametag was created for “Mom.” Also, a user's recall performance for nametags is sometimes not at the same high level as the recall performance for regular commands.

When a vehicle is in high noise conditions, the speech recognition system is sometimes unable to correlate a spoken word or phrase with the speaker dependent vocabulary stored in system.

In an exemplary situation, the user gives a command, “Call Mom,” and the command is not successful. The speech recognition application software receives a signal to noise ratio (SNR) speech error from the speech recognition engine in response to the unsuccessful command. The speech recognition application software sends an advisory message to the user to reduce the noise level in the car. A user can reduce the noise level in the vehicle by reducing fan levels, closing open windows, ending conversations in the vehicle or taking other appropriate noise reducing actions. The user repeats the command, “Call Mom,” and if the noise level is still too high, the cycle is repeated. After three attempts to receive a spoken command, the telematics system stops providing the advisory message to reduce the noise level. Then the user initiates a connection with the call center or directly dials the in-vehicle mobile phone to make the phone call.

In another exemplary situation, the user gives a command, “Call Mom,” and the speech recognition system correlates the spoken phrase with more than one of the speaker dependent phrases stored in speech recognition system. The speech recognition system then uses an elimination process to determine which phrase the user actually said. The speech recognition application software sends an message to the user asking, “Did you say call Tom?” The user says, “No.” The speech recognition application software sends a second message to the user asking, “Did you say call John?” The user says, “No.” After three attempts to correlate a spoken command, the telematics system stops trying to eliminate the possible matches. Then the user initiates a connection with the call center or directly dials the in-vehicle mobile phone to make the phone call.

Unsuccessful attempts to place calls using verbal commands have a negative impact on several important metrics in the speech recognition application, including a lower task completion rate. The user may also experience some frustration during the unsuccessful attempt.

It is desirable, therefore, to provide a method, system and computer usable medium that overcomes the limitations described above. It is desirable to provide a user with an alternative method to place a call using a nametag when high level noise conditions cause failure or uncertainty in matches within the voice recognition system. It is further desirable that the alternative method to place a call using a nametag in high level noise conditions is simple and easily recalled.

### SUMMARY OF THE INVENTION

One aspect of the present invention provides a method of initiating a wireless phone call from a mobile vehicle. The method includes storing at least one phone number in a vehicle communication system. The vehicle communication system includes a radio in communication with a telematics unit. The method further includes linking the stored phone number to a radio button, receiving a radio button input, while in a communication mode and placing the call from the telematics unit to the phone number linked to the radio button associated with the radio button input.

Another aspect of the present invention provides a radio preset system for initiating a phone call. The system includes means for storing at least one phone number in a vehicle communication system, means for linking the stored phone number to a radio button, means for receiving a radio button input, while in a communication mode and means for placing the call from the telematics unit to the phone number linked to the radio button associated with the radio button input.

A third aspect of the present invention provides a computer readable medium storing a computer program including computer readable code for storing at least one phone number in a vehicle communication system. The vehicle communication system includes a radio in communication with a telematics unit. The computer readable medium storing a computer program additionally includes computer readable code for linking the stored phone number to a radio button, computer readable code for receiving a radio button input while in a communication mode and computer readable code for placing the call from the telematics unit to the phone number linked to the radio button associated with the radio button input.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

Various embodiments of the present invention are illustrated by the accompanying figures, wherein:

FIG. 1 is a schematic diagram of a system for providing access to a telematics system in a mobile vehicle;

FIG. 2 illustrates a flowchart representative of one embodiment of a method of initiating a wireless phone call from a mobile vehicle in accordance with the present invention;

FIG. 3 illustrates a flowchart representative of one embodiment of a method of storing and linking a phone number in accordance with the present invention;

FIG. 4 illustrates a flowchart representative of one embodiment of a method of storing and linking a nametag associated with the phone number of FIG. 3; and

FIG. 5 illustrates a flowchart representative of one embodiment of a method of deleting a nametag in accordance with the present invention.

### DETAILED DESCRIPTION OF THE PRESENTLY PREFERRED EMBODIMENTS

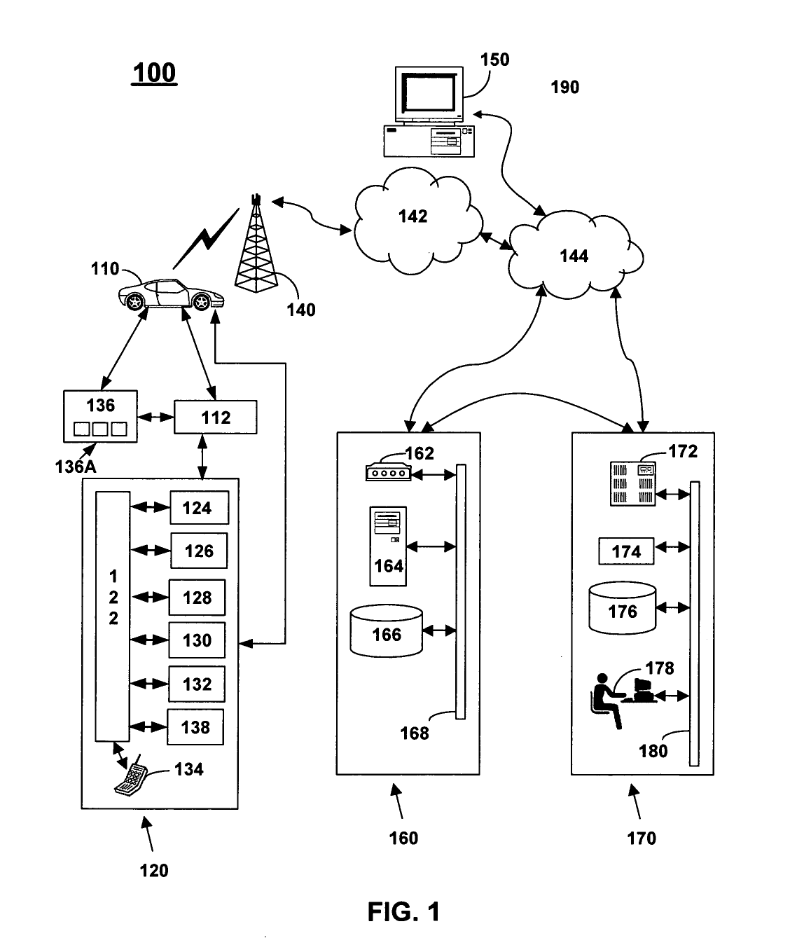

FIG. 1 illustrates one embodiment of system for data transmission over a wireless communication system, in accordance with the present invention at 100. Mobile vehicle communication system (MVCS) 100 includes a mobile vehicle communication unit (MVCU) 110, a vehicle communication network 112, a telematics unit 120, one or more wireless carrier systems 140, one or more communication networks 142, one or more land networks 144, one or more client, personal or user computers 150, one or more web-hosting portals 160, and one or more call centers 170. In one embodiment, MVCU 110 is implemented as a mobile vehicle equipped with suitable hardware and software for transmitting and receiving voice and data communications. MVCS 100 may include additional components not relevant to the present discussion. Mobile vehicle communication systems and telematics units are known in the art.

MVCU 110 may also be referred to as a mobile vehicle throughout the discussion below. In operation, MVCU 110 may be implemented as a motor vehicle, a marine vehicle, or as an aircraft. MVCU 110 may include additional components not relevant to the present discussion.

MVCU 110, via a vehicle communication network 112, sends signals to various units of equipment and systems (detailed below) within MVCU 110 to perform various functions such as unlocking a door, opening the trunk, setting personal comfort settings, and calling from telematics unit 120. In facilitating interactions among the various communication and electronic modules, vehicle communication network 112 utilizes network interfaces such as controller-area network (CAN), International Organization for Standardization (ISO) Standard 9141, ISO Standard 11898 for high-speed applications, ISO Standard 11519 for lower speed applications, and Society of Automotive Engineers (SAE) Standard J1850 for high-speed and lower speed applications.

MVCU 110, via telematics unit 120, sends and receives radio transmissions from wireless carrier system 140. Wireless carrier system 140 is implemented as any suitable system for transmitting a signal from MVCU 110 to communication network 142.

Telematics unit 120 includes a processor 122 connected to a wireless modem 124, a global positioning system (GPS) unit 126, an in-vehicle memory 128, a microphone 130, one or more speakers 132, and an embedded or in-vehicle mobile phone 134. In other embodiments, telematics unit 120 may be implemented without one or more of the above listed components, such as, for example GPS unit 126. Telematics unit 120 may include additional components not relevant to the present discussion.

Telematics unit 120 includes an in-vehicle speech recognition unit 138, which provides speech recognition capability. Speech recognition is sometimes referred to as voice-recognition. When the in-vehicle speech recognition unit 138 is activated, acoustic waves generated by a spoken phrase are received at the microphone 130 and analyzed by the processor 122 for a match with an audio file stored in memory 128. In one embodiment, the in-vehicle speech recognition unit 138 is external to the telematics unit 120 and is in communication with the telematics unit 120 via the vehicle communication network 112.

In one embodiment, a speech recognition application is installed in processor 122 that can translate human voice input through microphone 130 to digital signals. Processor 122 generates and accepts digital signals transmitted between telematics unit 120 and a vehicle communication network 112 that is connected to various electronic modules in the vehicle. In one embodiment, these digital signals activate the programming mode and operation modes, as well as provide for data transfers. In this embodiment, signals from processor 122 are translated into voice messages and sent out through speaker 132.

In one embodiment, processor 122 is a digital signal processor (DSP). Processor 122 is implemented as a microcontroller, microprocessor, controller, host processor, or vehicle communications processor. In an example, processor 122 is implemented as an application specific integrated circuit (ASIC). In another embodiment, processor 122 is implemented as a processor working in conjunction with a central processing unit (CPU) performing the function of a general purpose processor. GPS unit 126 provides longitude and latitude coordinates of the vehicle responsive to a GPS broadcast signal received from a one or more GPS satellite broadcast systems (not shown). In-vehicle mobile phone 134 is a cellular-type phone, such as, for example an analog, digital, dual-mode, dual-band, multi-mode or multi-band cellular phone. A radio 136 is located within the MVCU 110 and is communication with the telematics unit 120 via the vehicle communication network 112. In one embodiment, the radio 136 is in communication with the telematics unit 120 via a vehicle interface bus, which can be included in the vehicle communication network 112. The radio 136 has radio buttons. One of the radio buttons is shown as radio button 136A, which is representative of each and every radio button.

Processor 122 executes various computer programs that control programming and operational modes of electronic and mechanical systems within MVCU 110. Processor 122 controls communications (e.g., call signals) between telematics unit 120, wireless carrier system 140, call center 170 and the radio 136.

Communication network 142 includes services from one or more mobile telephone switching offices and wireless networks. Communication network 142 connects wireless carrier system 140 to land network 144. Communication network 142 is implemented as any suitable system or collection of systems for connecting wireless carrier system 140 to MVCU 110 and land network 144.

Land network 144 connects communication network 142 to client computer 150, web-hosting portal 160, and call center 170. In one embodiment, land network 144 is a public-switched telephone network (PSTN). In another embodiment, land network 144 is implemented as an Internet protocol (IP) network. In other embodiments, land network 144 is implemented as a wired network, an optical network, a fiber network, other wireless networks, or any combination thereof. Land network 144 is connected to one or more landline telephones. Communication network 142 and land network 144 connect wireless carrier system 140 to web-hosting portal 160 and call center 170.

Client, personal or user computer 150 includes a computer usable medium to execute Internet browser and Internet-access computer programs for sending and receiving data over land network 144 and optionally, wired or wireless communication networks 142 to web-hosting portal 160. Personal or client computer 150 sends user preferences to web-hosting portal through a web-page interface using communication standards such as hypertext transport protocol (HTTP), and transport-control protocol and Internet protocol (TCP/IP). In one embodiment, the data includes directives to change certain programming and operational modes of electronic and mechanical systems within MVCU 110. In operation, a client utilizes computer 150 to initiate setting or re-setting of user-preferences for MVCU 110. User-preference data from client-side software is transmitted to server-side software of web-hosting portal 160. User-preference data is stored at web-hosting portal 160.

Web-hosting portal 160 includes one or more data modems 162, one or more web servers 164, one or more databases 166, and a network system 168. Web-hosting portal 160 is connected directly by wire to call center 170, or connected by phone lines to land network 144, which is connected to call center 170. In an example, web-hosting portal 160 is connected to call center 170 utilizing an IP network. In this example, both components, web-hosting portal 160 and call center 170, are connected to land network 144 utilizing the IP network. In another example, web-hosting portal 160 is connected to land network 144 by one or more data modems 162. Land network 144 sends digital data to and from modem 162, data that is then transferred to web server 164. Modem 162 may reside inside web server 164. Land network 144 transmits data communications between web-hosting portal 160 and call center 170.

Web server 164 receives user-preference data from user computer 150 via land network 144. In alternative embodiments, computer 150 includes a wireless modem to send data to web-hosting portal 160 through a wireless communication network 142 and a land network 144. Data is received by land network 144 and sent to one or more web servers 164. In one embodiment, web server 164 is implemented as any suitable hardware and software capable of providing web services to help change and transmit personal preference settings from a client at computer 150 to telematics unit 120 in MVCU 110. Web server 164 sends to or receives from one or more databases 166 data transmissions via network system 168. Web server 164 includes computer applications and files for managing and storing personalization settings supplied by the client, such as door lock/unlock behavior, radio station preset selections, climate controls, custom button configurations and theft alarm settings. For each client, the web server potentially stores hundreds of preferences for wireless vehicle communication, networking, maintenance and diagnostic services for a mobile vehicle.

In one embodiment, one or more web servers 164 are networked via network system 168 to distribute user-preference data among its network components such as database 166. In an example, database 166 is a part of or a separate computer from web server 164. Web server 164 sends data transmissions with user preferences to call center 170 through land network 144.

Call center 170 is a location where many calls are received and serviced at the same time, or where many calls are sent at the same time. In one embodiment, the call center is a telematics call center, facilitating communications to and from telematics unit 120 in MVCU 110. In an example, the call center is a voice call center, providing verbal communications between an advisor in the call center and a subscriber in a mobile vehicle. In another example, the call center contains each of these functions. In other embodiments, call center 170 and web-hosting portal 160 are located in the same or different facilities.

Call center 170 contains one or more voice and data switches 172, one or more communication services managers 174, one or more communication services databases 176, one or more communication services advisors 178, and one or more network systems 180.

Switch 172 of call center 170 connects to land network 144. Switch 172 transmits voice or data transmissions from call center 170, and receives voice or data transmissions from telematics unit 120 in MVCU 110 through wireless carrier system 140, communication network 142, and land network 144. Switch 172 receives data transmissions from and sends data transmissions to one or more web-hosting portals 160. Switch 172 receives data transmissions from or sends data transmissions to one or more communication services managers 174 via one or more network systems 180.

Communication services manager 174 is any suitable hardware and software capable of providing requested communication services to telematics unit 120 in MVCU 110. Communication services manager 174 sends to or receives from one or more communication services databases 176 data transmissions via network system 180. Communication services manager 174 sends to or receives from one or more communication services advisors 178 data transmissions via network system 180. Communication services database 176 sends to or receives from communication services advisor 178 data transmissions via network system 180. Communication services advisor 178 receives from or sends to switch 172 voice or data transmissions.

Communication services manager 174 provides one or more of a variety of services, including enrollment services, navigation assistance, directory assistance, roadside assistance, business or residential assistance, information services assistance, emergency assistance, and communications assistance. Communication services manager 174 receives service-preference requests for a variety of services from the client via computer 150, web-hosting portal 160, and land network 144. Communication services manager 174 transmits user-preference and other data to telematics unit 120 in MVCU 110 through wireless carrier system 140, communication network 142, land network 144, voice and data switch 172, and network system 180. Communication services manager 174 stores or retrieves data and information from communication services database 176. Communication services manager 174 may provide requested information to communication services advisor 178.

In one embodiment, communication services advisor 178 is implemented as a real advisor. In an example, a real advisor is a human being in verbal communication with a user or subscriber (e.g., a client) in MVCU 110 via telematics unit 120. In another embodiment, communication services advisor 178 is implemented as a virtual advisor. In an example, a virtual advisor is implemented as a synthesized voice interface responding to requests from telematics unit 120 in MVCU 110.

Communication services advisor 178 provides services to telematics unit 120 in MVCU 110. Services provided by communication services advisor 178 include enrollment services, navigation assistance, real-time traffic advisories, directory assistance, roadside assistance, business or residential assistance, information services assistance, emergency assistance, and communications assistance. Communication services advisor 178 communicate with telematics unit 120 in MVCU 110 through wireless carrier system 140, communication network 142, and land network 144 using voice transmissions, or through communication services manager 174 and switch 172 using data transmissions. Switch 172 selects between voice transmissions and data transmissions.

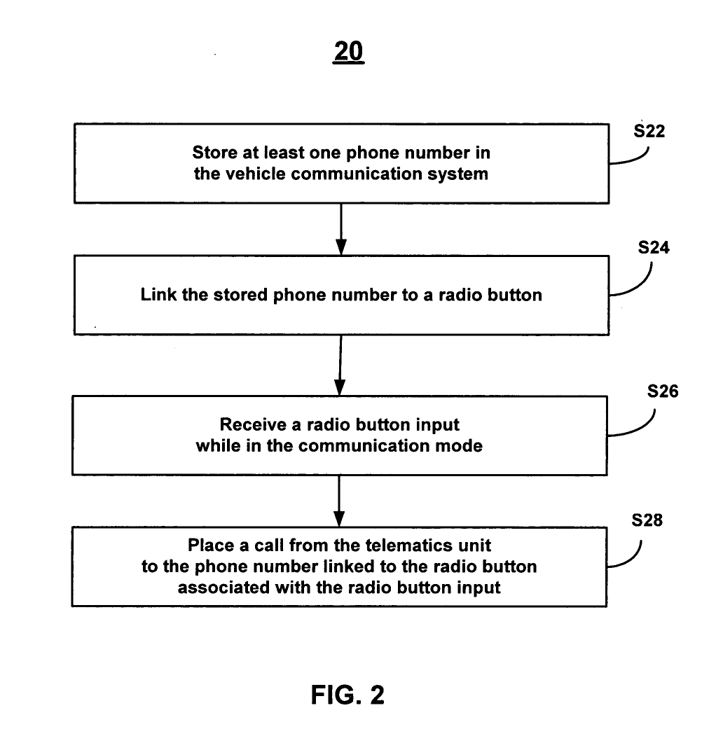

FIG. 2 illustrates a flowchart 20 representative of one embodiment of a method of initiating a wireless phone call from a mobile vehicle in accordance with the present invention. Implementation of this embodiment provides the user with the capability to make a phone call by pushing a radio button 136A while in the communication mode.

During stage S22, the radio preset application in the telematics unit 120 stores at least one phone number in the vehicle communication system. The vehicle communication system includes a radio 136 in communication with the telematics unit 120. Phone numbers may be stored in memory that is in communication with telematics unit 120. In one embodiment, the memory is memory 128 (FIG. 1). In one embodiment, phone numbers are stored in a memory (not shown) located in the radio 136.

During stage S24, the radio preset application in the telematics unit 120 links the stored phone number to a radio button 136A. The computer readable code for linking is stored in the memory 128 and is retrieved by the processor 122 to execute the linking. The computer readable code for linking modifies software in the radio 136. The software modification includes a mapping of the pushed radio button 136A to the stored phone number. After the software modification, a button push of a radio button 136A while telematics unit 120 is in a speech recognition mode, triggers the radio preset application to send a radio button input to the processor 122. In one embodiment, the phone number is linked to the available unlinked radio button 136A with the lowest radio button number.

During stage S26, the radio preset application receives a radio button input while the telematics unit 120 is in the communication mode. The telematics unit 120 is in the communication mode when the speech recognition system is activated. The phrases “communication mode” and “speech recognition mode” are used interchangeably within this document to describe the mode in which the speech recognition system is operating and the radio preset application can be initiated with the push of a radio button 136A.

When the telematics unit 120 is in the communication mode, the audio output from the radio 136 is muted and the radio buttons 136A are no longer operable to select a radio broadcast signal. Instead, a button push to an first radio button triggers the radio preset application to send a first radio button input to the processor 122. In response to receiving the first radio button input, the processor 122 retrieves the stored phone number linked to the associated the first radio button.

In one embodiment, a user pushes a radio button 136A if a call command or dial command is unsuccessful and if the radio button 136A was previously linked to the requested phone number, according to stages S22 and S24. In one embodiment, the user activates the in-vehicle speech recognition unit 138 and pushes the preset radio button 136A to initiate a phone call prior to a call command or dial command attempt.

During stage S28, the telematics unit 120 places a call from the MVCU 110 to the phone number linked to the radio button 136A associated with the radio button input. Processor 122 establishes a communication channel between telematics unit 120 and the telephone associated with the linked phone number. The communication channel is established over one or more wireless carrier systems 140, one or more communication networks 142 and one or more land networks 144.

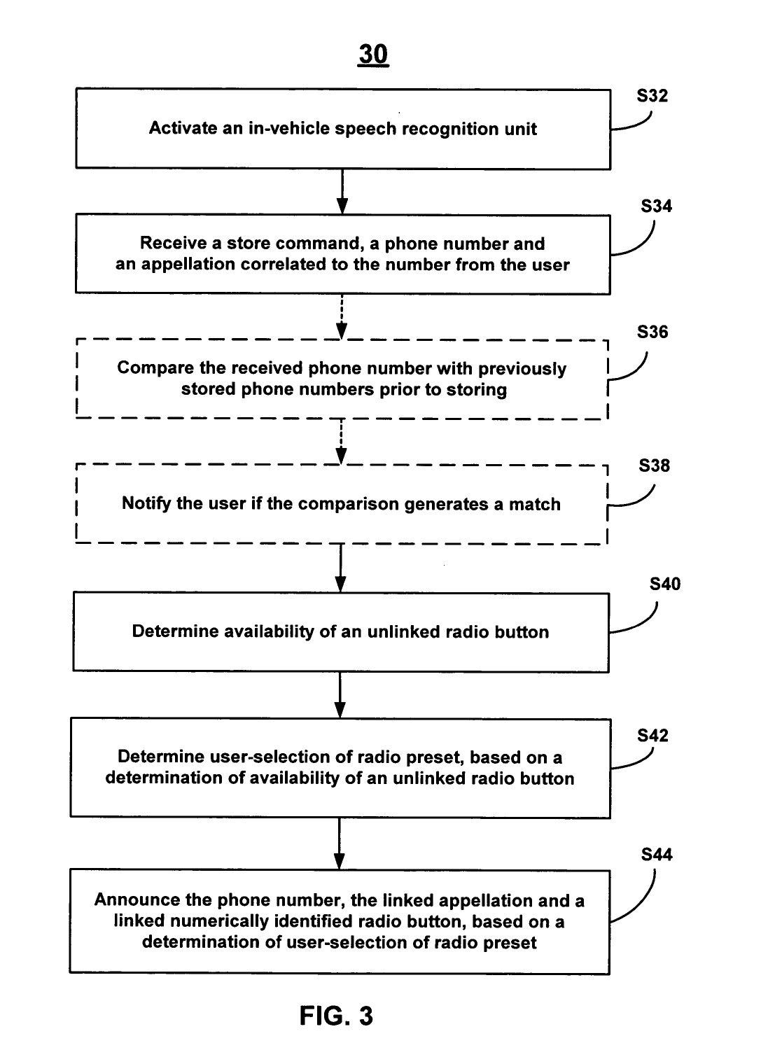

FIG. 3 illustrates a flowchart 30 representative of one embodiment of a method of storing and linking a phone number in accordance with the present invention. Flowchart 30 illustrates one embodiment of a method to accomplish stages S22 and S24 in flowchart 20 of FIG. 2. This flowchart 30 describes a method of checking for an unlinked radio button 136A and determining if a user wants to create a radio preset.

During stage S32, the user activates an in-vehicle speech recognition unit 138 within the telematics unit 120. The activation can be initiated by a button push or other input sent to telematics unit 120.

During stage S34, the in-vehicle speech recognition unit 138 receives a store command, a phone number and an appellation correlated to the number from the user.

In one embodiment, the user announces, “Store,” into microphone 130. The term “announces into the microphone 130” describes the process of speaking out loud within the vicinity of the microphone 130 in the MVCU 110, so that the microphone 130 picks up the acoustic vibrations from the voice. The vibrations received at the microphone 130 are transmitted as voice signals to the in-vehicle speech recognition unit 138. A speech recognition application installed in in-vehicle speech recognition unit 138 translates the human voice input through microphone 130 to digital signals. In one embodiment, a speech recognition application installed in processor 122 translates the human voice input through microphone 130 to digital signals. In another embodiment, the in-vehicle speech recognition unit 138 is part of the processor 122.

In another embodiment, a store command is initiated by a button push or other command, and the store command is then received by in-vehicle speech recognition unit 138.

In response to the received store command, the in-vehicle speech recognition unit 138 triggers the telematics unit 120 to store the audio files and/or text format files for all the following announced phrases until the in-vehicle speech recognition unit 138 receives a termination command. In one embodiment, the termination command is an oral command, such as, for example, “stop,” “end,” “finish,” or other phrases to indicate termination of the storage command. In another embodiment, the termination command is a button push or other input.

The user then announces a phone number, “#-#-#,” e.g., 555-234-5678, into microphone 130. The phone number is stored, in one embodiment, as a text format file in memory 128. In another embodiment, the phone number text format files are stored in a memory internal to the in-vehicle speech recognition unit 138. In another embodiment, the phone number text format files are stored in a memory internal radio 136.

Then the user announces an appellation, “XXXX,” e.g., “Mary”, to associate with the announced phone number. In one embodiment, the appellation is an identifying phrase such as hospital, police or car repair center. In another embodiment, the appellation is the name of an individual associated with the phone number. In one embodiment, the appellation is a spoken phrase. In another embodiment, the appellation is received using a button push, or using another data entry device. The appellation is stored as a nametag including an file of the entered appellation and is stored in memory that is in communication with telematics unit 120. In one embodiment, the nametag is an audio file of the spoken appellation. In one embodiment, the nametag is stored in memory 128. In another embodiment, the nametag audio files are stored in a memory internal to the in-vehicle speech recognition unit 138. In another embodiment, the nametag audio files are stored in a memory internal to the radio 136.

Stage S36 is optional. During stage S36, the received phone number is compared with previously stored phone numbers. In one embodiment, processor 122 does the comparing. The processor 122 in the telematics unit 120 looks for a match between the text format file for the phone number stored during stage S34 and the text format files for previously stored phone numbers. In one embodiment, if the processor 122 finds a match, the processor 122 checks to see if the text format file for the matched previously stored phone number is linked with a nametag and/or a radio button 136A.

Stage S38 is optional and based on completion of stage S36. During stage S38, the telematics unit 120 notifies the user if the comparison generates a match. Processor 122 generates digital signals, which are translated into voice messages and sent out through speakers 132 to announce, for example, “The telephone number ###-###-#### is already stored.” In one embodiment, the voice messages sent out through speakers 132 announce, “The telephone number ###-###-#### is already stored with nametag XXXX and can be accessed by radio button N,” where N numerically identifies one of the radio buttons 136A on radio 136. In an exemplary announcement, the telematics unit 120 sends out a voice message, “The telephone number 555-234-5678 is already stored with the nametag Mary and can be accessed by radio button 4.”

During stage S40, the radio preset system determines the availability of an unlinked radio button 136A. An unlinked radio button 136A is any radio button that does not have a phone number linked to the radio button. The radio preset system checks each radio button 136A for a mapping to a stored phone number until a radio button 136A without mapping is found. If there is no mapping, the radio button 136A is unlinked. If all the radio buttons 136A are linked, there is no determination of availability.

During stage S42, the telematics unit 120 determines user-selection of radio preset, based on a determination of availability of an unlinked radio button 136A. If there is an available unlinked radio button 136A, the processor 122 generates digital signals, which are translated into voice messages and sent out through speakers 132 to announce, for example, “Do you want radio preset?” In one embodiment, the in-vehicle speech recognition unit 138 generates a digital signal that is transmitted via vehicle communication network 112 to the processor 122 to be sent out from speakers 132 as a voice message.

The telematics unit 120 then monitors for a user response. The user response, in one embodiment, is an oral response of, for example, “Yes,” or, “No,” to determine if there is a user-selection of radio preset. In another embodiment, the user response is a button push or other input. If the user response is negative, there is not a determination of user-selection of radio preset. If the user response is positive, there is a determination of user-selection of radio preset. In one embodiment, microphone 130 receives the user's response. In another embodiment, the user response is received in response to a button push or other input. In embodiments that include an oral input, the oral input is processed by in-vehicle speech recognition unit 138.

During stage S44, the telematics unit 120 provides the phone number, the linked appellation and the number of the linked numerically identified radio button 136A, based on a determination of user-selection of radio preset. The phone number, linked appellation and radio button number may be provided audibly or using a display screen. Thus, for example, if the user responds with a, “Yes,” to the question of stage S42, the telematics unit 120 sends out a voice message, “Phone number ###-###-#### is stored as the nametag XXXX with the radio preset button N,” from the speakers 132. In an exemplary announcement, the telematics unit 120 sends out a voice message, “Phone number 555-234-5678 is stored as the nametag Mary with the radio preset button 4.”

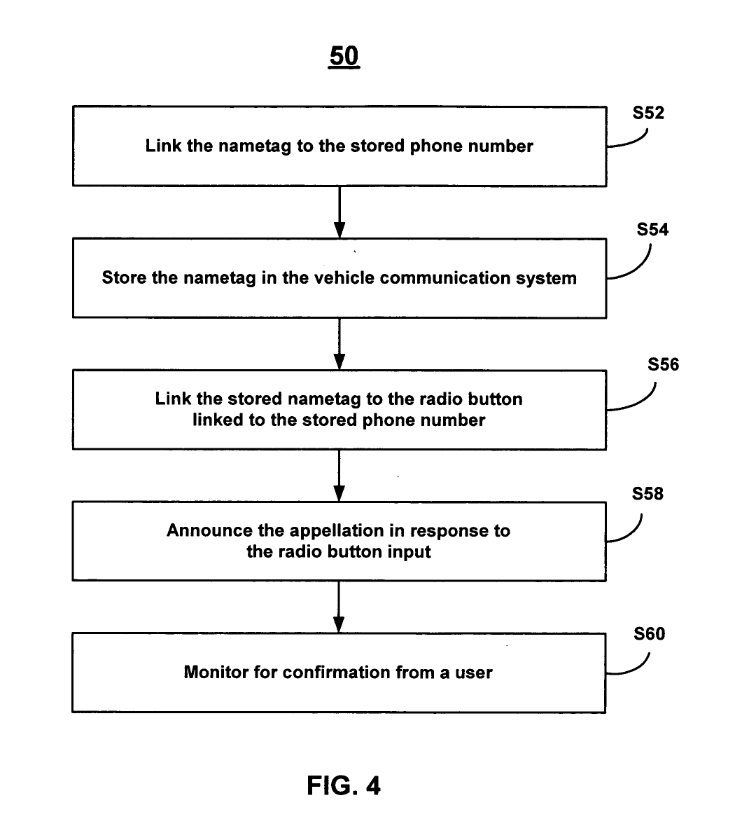

FIG. 4 illustrates a flowchart 50 representative of one embodiment of a method of storing and linking a nametag associated with a phone number. Flowchart 50 describes how a nametag is linked to a radio button 136A and how the user is prompted to confirm an announced phone number before a radio preset based telephone call is initiated.

During stage S52, the radio preset application in the telematics unit 120 links the nametag to the stored phone number associated with a radio button 136A. The stored phone number is the number announced as, “###-###-####,” as described above with reference to stage S34 in flowchart 30 of FIG. 3.

The nametag is the phrase announced as, “XXXX,” as described above with reference to stage S34 in flowchart 30 of FIG. 3. After the stored phone number and nametag are linked, retrieval of either the phone number or the nametag from storage initiates the retrieval of the other data.

In one embodiment, the computer readable code for linking is stored in the memory 128 and is retrieved by the processor 122 to execute the linking. The computer readable code for linking the nametag to the stored number modifies software in the radio 136. The software modification includes a mapping of the nametag to the stored phone number. In another embodiment, the computer readable code for linking is stored in the radio 136.

During stage S54, the radio preset application stores the nametag in the vehicle communication system. In one embodiment, the computer readable code for storing a nametag is stored in memory 128 and is retrieved by the processor 122 to execute the storing. In one embodiment, the computer readable code for storing a nametag is stored in radio 136 and is retrieved by the processor 122 to execute the storing. The audio files for nametags are stored in the memory 128 of the telematics unit 120. In one embodiment, audio files for nametags are stored in a memory (not shown) located in the radio 136.

During stage S56, the radio preset application links the stored nametag to the radio button 136A, which is also linked to the stored phone number. As described above with reference to stage S24 in flowchart 20 of FIG. 2, linking a file to a radio button 136A includes modifying the software in radio 136 to map the radio button 136A to the file, such as, in this stage, the audio file of the stored nametag. The linking details are not repeated here.

During stage S58, the telematics unit 120 announces the appellation in response to the radio button input. A button push to a radio button 136A triggers the radio preset application to send a radio button input to the processor 122. In response to receiving the radio button input, the processor 122 announces both the stored phone number and the linked nametag associated the radio button 136A. The processor 122 retrieves the stored audio file for the nametag and generates digital signals, which are translated into voice messages. The telematics unit 120 sends the voice messages out through speakers 132 to announce the appellation, which was used to form the audio file for the nametag. As used herein, “announcing” comprises an audible recitation of the data, as well as a display of the data on a display screen, such as a navigation monitor or radio dial.

In one embodiment, the processor 122 retrieves the stored audio file for the nametag and the linked stored text format file for the phone number and announces the appellation and the phone number. In another embodiment, the processor 122 retrieves the stored audio file for the nametag and the linked stored text format file for the phone number and announces the phone number.

During stage S60, the telematics unit 120 monitors for confirmation from a user that the announced appellation correctly identifies the person or facility that the user would like to call. If confirmation is received, the telematics unit 120 places the call from the telematics to the phone number linked to the nametag. In one embodiment, confirmation requires the users to enter a confirmation input such say, “Yes,” into the microphone 130. In another embodiment, the user confirms using a button push or other input.

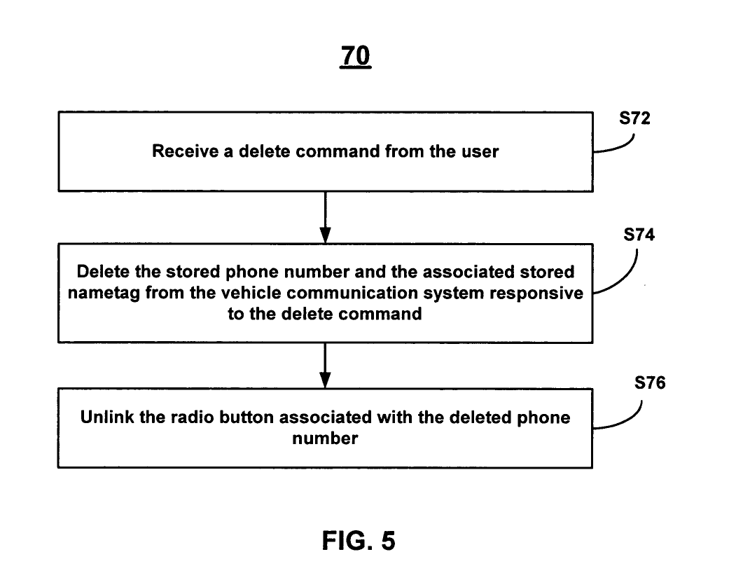

FIG. 5 illustrates a flowchart 70 representative of one embodiment of a method of deleting a nametag in accordance with the present invention. During stage S72, the in-vehicle speech recognition unit 138 receives a delete command from the user and a phone number or an appellation correlated to the number from the user. For example, the user announces, “Delete,” into microphone 130. In another example, a delete command is actuated by a button push and received in telematics unit 120. The in-vehicle speech recognition unit 138 recognizes the delete phrase for oral inputs and telematics unit 120 recognizes the delete command for button push inputs.

In stage S74, responsive to the received delete command, telematics unit 120 deletes the audio files and/or text format files for all the announced phrases that follow the delete command until the in-vehicle speech recognition unit 138 recognizes a termination command. The operation of the microphone 130, the processor 122 and the in-vehicle speech recognition unit 138 in receiving and recognizing phrases was described above with respect to stage S34 in flowchart 30 of FIG. 3 and is not repeated here.

For example, if the user announces, “Delete ###-###-####,” e.g., 555-234-5678, into microphone 130, the processor 122, the memory 130 and the in-vehicle speech recognition unit 138 operate to check for a match of the text format file of the announced phone number with the text format file of the stored phone numbers. If a match is found, the matched phone number is deleted from memory 128 and/or a memory in the radio 136. The nametag linked to the deleted phone number is also deleted from memory 128 and/or a memory in the radio 136.

In an alternative embodiment, the user announces, “Delete XXXX,” e.g., Mary, into microphone 130. The processor 122, the memory 130 and the in-vehicle speech recognition unit 138 operate to check for a match of the audio file of the announced appellation with the audio files of the stored nametags. If a match is found, the matched nametag is deleted from memory 128 and/or a memory in the radio 136. The phone number linked to the deleted nametag is also deleted from memory 128 and/or a memory in the radio 136.

During stage S76, the radio preset application unlinks the radio button 136A associated with the deleted phone number. The telematics unit 120 transmits a signal to the radio 136 via the vehicle communication network to delete the phone number mappings to the radio button 136A. Mappings to the radio preset of the nametag associated with the announced phone number are also deleted. The unlinked radio button 136A is then available for linking to a new phone number and an associated nametag.

In one embodiment, the delete command is used to delete all the stored phone numbers and associated nametags in the radio preset system. In this embodiment, the user announces, “Delete all radio preset,” to delete all stored phone numbers and associated nametags in the radio preset system.

While the embodiments, of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A method of initiating a wireless phone call from a mobile vehicle, the method comprising:
storing at least one phone number in a vehicle communication system, the vehicle communication system including a radio in communication with a telematics unit;
linking the stored phone number to a radio button;
receiving a radio button input, while in a communication mode; and
placing the call from the telematics unit to the phone number linked to the radio button associated with the radio button input.

2. The method of claim 1, wherein the communication mode comprises a speech recognition mode, and wherein a nametag including an audio file of an appellation is associated with the stored phone number; and
further comprising:
linking the nametag to the stored phone number;
storing the nametag in the vehicle communication system;
linking the stored nametag to the radio button linked to the stored phone number;
announcing the appellation in response to the radio button input; and
monitoring for a confirmation from a user prior to placing the call.

3. The method of claim 2, wherein the method further comprises:
receiving a delete command from the user;
deleting the stored phone number and the associated stored nametag from the vehicle communication system responsive to the delete command; and
unlinking the radio button associated with the deleted phone number.

4. The method of claim 3, wherein the deleting comprises deleting all stored phone numbers and associated nametags.

5. The method of claim 2, wherein the storing comprises:
activating an in-vehicle speech recognition unit;
receiving a store command, a phone number and an appellation correlated to the phone number from the user; and
determining availability of an unlinked radio button.

6. The method of claim 5, wherein the method further comprises:
comparing the received phone number with previously stored phone numbers; and
notifying the user if the comparison generates a match.

7. The method of claim 5, wherein the linking the stored phone number to a radio button comprises:
determining user-selection of radio preset, based on a determination of availability of an unlinked radio button; and
announcing the phone number, the linked appellation and a linked numerically identified radio button, based on a determination of user-selection of radio preset.

8. The method of claim 1, wherein the linking the stored phone number to a radio button comprises linking to an unlinked radio button having a lowest radio button number.

9. The method of claim 1, wherein the radio button input is sent in response to a user activating a radio button.

10. A radio preset system for initiating a phone call, the system comprising:
means for storing at least one phone number in a vehicle communication system;
means for linking the stored phone number to a radio button;
means for receiving a radio button input, while in a communication mode; and
means for placing the call from the telematics unit to the phone number linked to the radio button associated with the radio button input.

11. The system of claim 10, wherein the system further comprises:
means for linking a nametag including an appellation to the stored phone number;
means for storing the nametag in the vehicle communication system;
means for linking the stored nametag to the radio button linked to the stored phone number;
means for announcing the appellation in response to the radio button input; and
means for monitoring for a confirmation from a user prior to placing the call.

12. The system of claim 11, wherein the system further comprises:
means for receiving a delete command from the user;
means for deleting the stored phone number and the stored nametag from the vehicle communication system responsive to the delete command; and
means for unlinking the radio button associated with the deleted phone number.

13. A computer readable medium storing a computer program comprising:
computer readable code for storing at least one phone number in a vehicle communication system, the vehicle communication system including a radio in communication with a telematics unit;
computer readable code for linking the stored phone number to a radio button;
computer readable code for receiving a radio button input, while in a communication mode; and
computer readable code for placing the call from the telematics unit to the phone number linked to the radio button associated with the radio button input.

14. The medium of claim 13, wherein the communication mode comprises a speech recognition mode, and wherein a nametag, including an audio file of an appellation, is associated with the stored phone number.

15. The medium of claim 14, wherein the medium further comprises:
computer readable code for linking the nametag to the stored phone number;
computer readable code for storing the nametag in the vehicle communication system;
computer readable code for linking the stored nametag to the radio button linked to the stored phone number;
computer readable code for announcing the appellation in response to the radio button input; and
computer readable code for monitoring for a confirmation from a user prior to placing the call.

16. The medium of claim 15, wherein the medium further comprises:
computer readable code for receiving a delete command from the user;
computer readable code for deleting the stored phone number and the associated stored nametag from the vehicle communication system; and
computer readable code for unlinking the radio button associated with the deleted phone number.

17. The medium of claim 15, wherein the computer readable code for storing comprises:
computer readable code for activating an in-vehicle speech recognition unit;
computer readable code for receiving a store command, the phone number and the appellation correlated to the phone number from the user; and
computer readable code for determining availability of an unlinked radio button.

18. The medium of claim 17, wherein the medium further comprises:
computer readable code for comparing the received phone number with previously stored phone numbers; and
computer readable code for notifying the user if the comparison generates a match.

19. The medium of claim 17, wherein the computer readable code for linking the stored phone number to a radio button comprises:
computer readable code for determining user-selection of radio preset, based on a determination of availability of an unlinked radio button; and
computer readable code for announcing the phone number, the linked appellation and a linked numerically identified radio button, based on a determination of user-selection of radio preset.

20. The medium of claim 13, wherein the computer readable code for linking the stored phone number to a radio button comprises computer readable code for linking to an unlinked radio button having a lowest radio button number.
